(19) United States
(12) Patent Application Publication
(10) Pub. No.: US 2017/0159700 A1
(43) Pub. Date: Jun. 8, 2017

(54) Length-adjustable Samer Rod

(71) Applicant: Airbus Operations GmbH, Hamburg (DE)

(72) Inventors: Gerd Stahl, Hamburg (DE); Adnan Topal, Hamburg (DE)

(21) Appl. No.: 15/366,132

(22) Filed: Dec. 1, 2016

(30) Foreign Application Priority Data
Dec. 3, 2015 (DE) 102015121018.5

(51) Int. Cl. F16C 7/06

(52) U.S. Cl. CPC F16C 7/06

(57) ABSTRACT

A Samer rod has length adjustable along a longitudinal axis. A first element extends along the axis between a first coupling end and an engagement section end, and a second element extends along the axis between a second coupling end and a receiving end. A receiving hole extends along the axis, inside the first element, away from the receiving end to the second coupling end. The engagement section has an outer row of teeth extending parallel to the axis with evenly spaced teeth extending perpendicular to the axis in the circumferential direction of the engagement section. The receiving hole has an inner row of teeth extending parallel to the axis with evenly spaced teeth extending perpendicular to the axis in the circumferential direction of the receiving hole wall. The spacing of the teeth of the two rows in the direction of the axis corresponds to one another.

### CROSS-REFERENCES TO RELATED APPLICATIONS

This application claims the benefit of the German patent application No. 10 2015 121 018.5 filed on Dec. 3, 2015, the entire disclosures of which are incorporated herein by way of reference.

### BACKGROUND OF THE INVENTION

The present invention relates to a Samer rod, which extends along a longitudinal axis and the length of which is adjustable along the longitudinal axis, having a first element, which extends along the longitudinal axis between a first coupling end and the end of an engagement section, and having a second element, which extends along the longitudinal axis between a second coupling end and a receiving end.

Samer rods are well-known from the prior art and are used to keep elements at a specified spacing from one another inside the structure of an aircraft. It is thus known from EP 2 240 364 B1, for example, that Samer rods are used to keep a floor arrangement in a specified position relative to the fuselage frame.

It is, however, often desirable to be able to adjust the length of the Samer rods in a simple way in order to adapt the Samer rods to the specified installation position so as to avoid having to produce a plurality of Samer rods with different lengths. It is also desirable that the length setting is reliably maintained and that there is no risk of the adjustment mechanism being released, which would then compromise the stability of the Samer rod.

### SUMMARY OF THE INVENTION

Based on the prior art, it is therefore an object of the present invention to provide a length-adjustable Samer rod, the adjustment mechanism of which can be reliably secured and which has adequate stability in the longitudinal direction in spite of the adjustability.

According to the invention, this object is achieved by means of a Samer rod
having a first element, which extends along the longitudinal axis between a first coupling end and the end of an engagement section,
having a second element, which extends along the longitudinal axis between a second coupling end and a receiving end, wherein a receiving hole extends away from the receiving end to the second coupling end, which receiving hole extends along the longitudinal axis inside the first element,
wherein the engagement section is provided with an outer row of teeth, which extends parallel to the longitudinal axis and has evenly spaced teeth extending perpendicular to the longitudinal axis in the circumferential direction of the engagement section,
wherein the receiving hole is provided with an inner row of teeth, which extends parallel to the longitudinal axis and has evenly spaced teeth extending perpendicular to the longitudinal axis in the circumferential direction of the wall of the receiving hole, the spacing of which in the direction of the longitudinal axis corresponds to the spacing of the teeth of the outer row of teeth in the direction of the longitudinal axis,
wherein the engagement section is received in the receiving hole in such a way that the first element can be pivoted about the longitudinal axis between a released position and a locked position relative to the second element,
wherein the inner and the outer rows of teeth are disengaged in the released position, so that the engagement section can be moved parallel to the longitudinal axis in the receiving hole, and wherein the rows of teeth engage with one another in the locked position and a movement of the engagement section relative to the receiving hole along the longitudinal axis is prevented,
having a locking ring, which can be moved along the longitudinal axis and is held in a non-twisting manner on the engagement section, and
having a catch device, which is mounted on the receiving end adjustable between a first position and a second position, wherein the catch device is designed such that, in the first position, the locking ring is coupled to the receiving end in a non-rotating manner and unmovable along the longitudinal axis, and that, in the second position, a rotation of the locking ring relative to the receiving end is permitted.

The Samer rod according to the invention thus has a first element, which is provided with a coupling end, which can be designed, for example, as an eyelet, wherein the first element extends along a longitudinal axis away from the coupling end and an engagement section with a free end is formed at a distance from the coupling end. The engagement section in turn has an outer row of teeth, in the form of a conventional toothing, for example, wherein the row of teeth extends parallel to the longitudinal axis of the Samer rod and has evenly spaced teeth which extend perpendicular to the longitudinal axis and parallel to the circumferential direction of the engagement section.

In addition, the Samer rod according to the invention has a second element, which extends from a second coupling end, which can also be formed as an eyelet, along the longitudinal axis to a receiving end. A receiving hole extending parallel to the longitudinal axis is formed on the receiving end, which receiving hole has an inner row of teeth on its inner circumferential wall. This row of teeth can likewise be formed as a toothing, so that it in any case has teeth extending perpendicular to the longitudinal axis and in the circumferential direction along the wall of the receiving hole, which are evenly spaced apart from one another, with the spacing of the teeth of the inner row of teeth corresponding to the spacing of the teeth of the outer row of teeth. In addition, the inner and the outer rows of teeth are designed such that the width of the teeth of the inner row of teeth measured in the direction of the longitudinal axis corresponds to the spacing of the teeth of the outer row of teeth. In a reciprocal manner, the width of the teeth of the outer rows of teeth measured in the direction of the longitudinal axis corresponds to the spacing of the teeth of the inner row of teeth.

Finally, the engagement section and the receiving hole are each formed in cross section along their extension such that the engagement section can be inserted into the receiving hole and, regardless of how deeply the engagement section is inserted into the receiving hole, the first element and the second element can be pivoted about the longitudinal axis relative to one another between a locked position and a released position. In the locked position, the inner and the outer rows of teeth engage with one another, so that the first element cannot then be moved relative to the second element along the longitudinal axis, whereas this can occur in the released position since the rows of teeth are then disengaged.

Finally, a locking ring is provided, which can be moved along the engagement section, but cannot be twisted relative to the engagement section. A catch device is provided on the receiving end which can be shifted between a first and a second position, with the locking ring being coupled in a non-rotating manner to the second element or the receiving end by means of the catch device when the catch device is in the first position. This prevents the first element and the second element twisting against one another so that, by means of the catch device, the first element and the second element can be held in the locked position.

If, however, it is desirable to adjust the length of the Samer rod, the catch device must firstly be moved into the second position, so that the locking ring and thus also the first element can be twisted relative to the second element, so that the arrangement can be moved into the released position. The first element can subsequently be moved axially relative to the second element and then be moved back into the locked position.

The Samer rod according to the invention can thus be easily adjusted in terms of its length and is nevertheless reliably secured when in a specified setting so that this setting cannot be unintentionally released.

In a preferred embodiment, the locking ring has first engagement elements on its outer circumferential surface, with the catch device having a catch element, which is pivotably held about a pivot axis extending perpendicular to the longitudinal axis in the area of the receiving end on the second element and can be pivoted between the first position and the second position, with the catch element engaging with the engagement elements in the first position and being pivoted away from the locking ring in the second position, so that the catch element is disengaged from the engagement elements.

In this preferred embodiment, the catch device is constructed in a particularly simple way by being held in a pivotable manner on the receiving end. The first position, in which the locking ring is prevented from realizing a rotation relative to the second element or the receiving end, is attained by pivoting of the catch element towards the longitudinal axis. Accordingly, the released position is attained by a pivoting of the catch element away from the longitudinal axis.

In a particularly preferred manner, the engagement elements are formed here as a toothing on the outer circumference of the locking ring, wherein the teeth of the toothing extend parallel to the longitudinal axis. Such a construction can be produced particularly easily.

In another preferred manner, the catch element has a U-shaped form, with two shanks which are connected to one another via a central section, wherein the free ends of the shanks are pivotably connected to the receiving end and wherein, in the first position, the shanks engage with the toothing and the central section extends along the side of the locking ring facing away from the receiving end.

Thanks to the central section which, in the first position, abuts the side of the locking ring facing away from the receiving ends, it is easily ensured that the locking ring in the locked state cannot move in the axial direction away from the receiving end. The catch device can, nevertheless, be easily produced.

In another preferred embodiment, the inner row of teeth has several inner tooth row sections, which extend linearly parallel to the longitudinal axis and spaced apart from one another in the circumferential direction of the wall of the receiving hole. The outer row of teeth has several outer tooth row sections, which extend linearly parallel to the longitudinal axis and spaced apart from one another in the circumferential direction of the engagement section, wherein the width of the inner tooth row sections in the circumferential direction of the wall of the receiving hole corresponds to the spacing of the outer tooth row sections in the circumferential direction of the engagement section and/or the width of the outer tooth row sections in the circumferential direction of the engagement section corresponds to the spacing of the inner tooth row sections in the circumferential direction of the wall of the receiving hole.

If the rows of teeth in the receiving hole and on the engagement section have several sections extending parallel to one another, with each of the spacings between the sections in the circumferential direction being selected such that these spacings correspond to the width of the sections on the respective other element, this ensures, on the one hand, that there are only clearly defined relative positions between the first and the second element in which these elements can be axially moved against one another. In the locked position, it is furthermore ensured that, due to the large engagement surface between the tooth row sections, a large-surface engagement and thus a high load-bearing capacity in the axial direction are achieved. Nevertheless, a release requires only a relatively small pivoting in the circumferential direction according to the width of the tooth row sections, thus keeping the releasing effort minimal.

Finally, it is preferred that the first coupling end and the engagement section are connected to one another such that they can rotate about the longitudinal axis and/or the second coupling end and a section of the second element, in which the receiving hole extends, are connected to one another such that they can rotate about the longitudinal axis. In this case, the length of the Samer rod according to the invention can be adjusted even when the coupling ends are permanently installed.

### BRIEF DESCRIPTION OF THE DRAWINGS

The present invention is explained below with reference to drawings showing a preferred exemplary embodiment of the present invention, in which

FIG. 1 shows an exemplary embodiment of a Samer rod according to the invention in a longitudinal section,

FIG. 2 shows an enlarged cross-section view of FIG. 1,

FIGS. 3A and 3B show sections along the lines III-III and IV-IV of FIG. 1 and

FIG. 4 shows different views of the locking ring of the exemplary embodiment of FIG. 1.

### DETAILED DESCRIPTION OF THE PREFERRED EMBODIMENTS

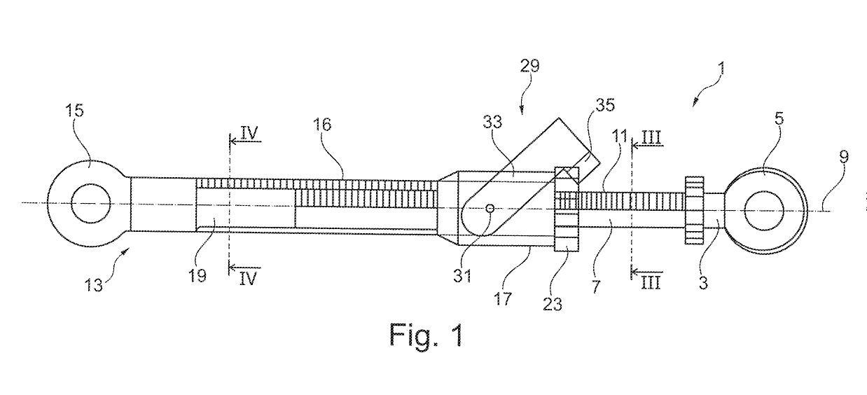

It is seen from FIG. 1 that the exemplary embodiment of a Samer rod 1 according to the invention has a first element 3, which has a first coupling end 5 in the form of an eyelet, away from which a cylindrical engagement section 7 extends along a longitudinal axis 9 of the Samer rod 1 to a free end of the engagement section 7. The coupling end 5 is rotatably connected to the engagement section 7 about the longitudinal axis 9, so that the first coupling end 5 can be twisted relative to the engagement section 7.

An outer row of teeth in the form of four outer tooth row sections 11 extending linearly parallel to the longitudinal axis 9 is formed on the linearly extending engagement section 7, which outer tooth row sections are evenly distributed over the circumference of the engagement section 7 (see FIG. 3B). In particular, the outer tooth row sections 11 have a uniform width in the circumferential direction of the engagement section 7 perpendicular to the longitudinal axis 9. The outer tooth row sections 11 are formed by teeth which extend in the circumferential direction of the engagement section 7 perpendicular to the longitudinal axis 9 and which are evenly spaced apart from one another.

As is also seen from FIG. 1, the exemplary embodiment of the Samer rod 1 has a second element 13, which also extends along the longitudinal axis 9 and has a second coupling end 15 in the form of an eyelet. A section 16 of the second element 13 extends away from the second coupling end 15 linearly along the longitudinal axis 9 to a receiving end 17, in which a receiving hole 19 is formed extending away from the receiving end 17 linearly along the longitudinal axis 9. The receiving hole 19 extends in the section 16. In the case of the second element 13 too, the second coupling end 15 is rotatably connected to the remaining part of the second element 13 about the longitudinal axis 9, namely, the section 16.

As can also be seen in FIG. 3A, inner tooth row sections 21 are formed in the receiving hole 19, which extend linearly parallel to the longitudinal axis 9 along the circumferential wall of the receiving hole 19. The inner tooth row sections 21 are formed by teeth extending perpendicular to the longitudinal axis 9 along the circumferential wall of the receiving hole 19, which are evenly spaced apart from one another, wherein the spacing of the teeth measured in the direction of the longitudinal direction 9 of the inner tooth row sections 21 corresponds to the width of the teeth of the outer tooth row sections 11. In a reciprocal manner, the width of the teeth of the inner tooth row sections 21 measured parallel to the longitudinal axis 9 is identical to the spacing of the teeth of the outer tooth row section 11. The tooth row sections 11, 21 can thus engage with one another when they are brought into alignment.

The spacing of the inner tooth row sections 21 from one another measured in the circumferential direction corresponds to the width of the outer tooth row sections 11 on the engagement section 7.

The previously described arrangement of the inner and outer tooth row sections 11, 21 allows the engagement section to be inserted into the receiving hole 19 and moved axially when the outer tooth row sections 11 are offset in the circumferential direction to the inner tooth row sections 21. When the engagement section 7 or the first element 3 is, however, pivoted relative to the second element 13 about the longitudinal axis 9, the teeth of the outer tooth row sections 11 can engage with the teeth of the inner tooth row sections 21, so that the axial position of the first element 3 relative to the second element 13 is fixed. When the tooth row sections 11, 21 are engaged with one another, the locked position is attained, while the released position exists when the first and the second elements 3, 13 are pivoted relative to one another in such a way that the tooth row sections 11, 21 are disengaged.

Because the spacing between the inner tooth row sections 21 corresponds to the width of the outer tooth row sections 11, the latter can be positioned between the inner tooth row sections 21, and an axial translational movement is permitted.

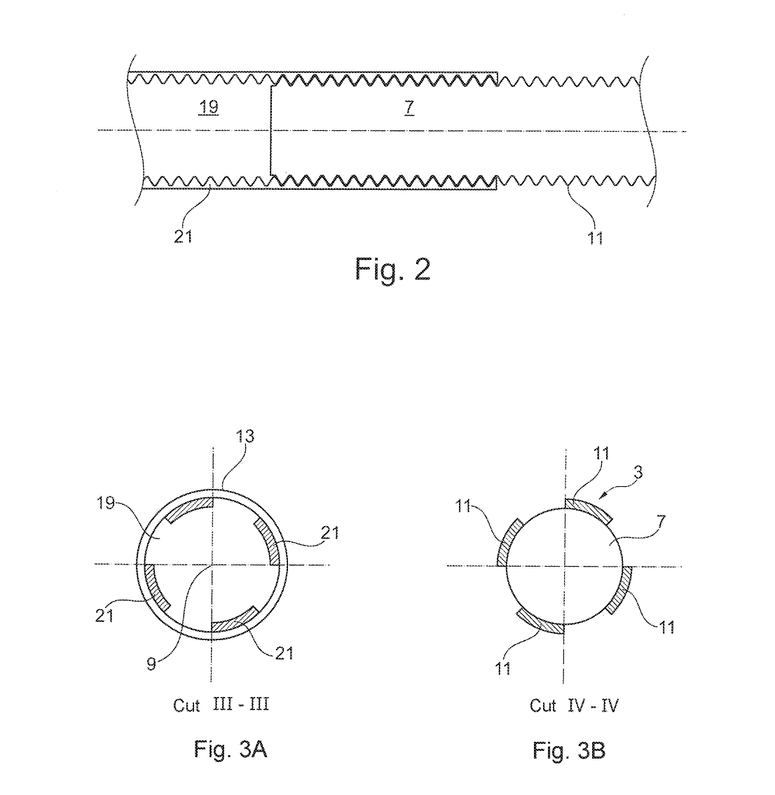

FIG. 2 is an enlarged depiction of the engagement of the inner tooth row sections 21 with the outer tooth row sections 11.

The engagement section 7 or the first element 3 can thus be pivoted relative to the second element 13 between a locked position, in which the tooth row sections 11, 21 or the tooth rows are engaged with one another, and a released position, in which the tooth row sections 11, 21 are disengaged, and, in the released position, the engagement section 7 can be moved axially relative to the receiving hole 19.

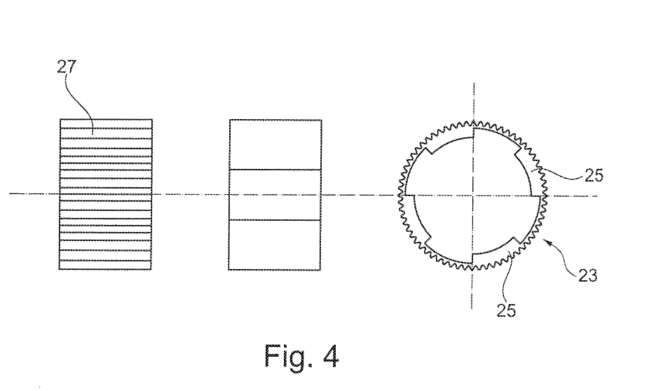

Finally, it can be seen in FIGS. 1 and 4 that a locking ring 23 is provided on the engagement section 7 of the first element 3, with the inner circumferential wall of the locking ring having projections 25, the width of which in the circumferential direction corresponds to the width of the spacing between adjacent outer tooth row sections 11. The projections 25 are distributed in such a way over the circumference of the locking ring 23 that the projections 25 fit exactly in the spaces between the outer tooth row sections 11. This results in the locking ring 23 being mounted in a non-twisting manner but axially movable on the engagement section 7. Finally, a toothing 27 is provided on the outer circumference of the locking ring 3.

It can also be seen from FIG. 1 that, adjacent to the receiving end 17, a catch element 29 is held on the second element 13, about a pivot axis 31, which extends perpendicular to the longitudinal axis 9. The catch element 29 is formed U-shaped and has shanks 33 and a central section 35 connecting them, with the free ends of the shanks 33 being linked pivotable about the pivot axis 31 to the second element 23.

The catch element 29 can be pivoted between a first position, in which the shanks 33 can engage in the region of the central section 35 with the toothing 27 of the locking ring 23, when the locking ring abuts directly on the receiving end 17, and a second position, in which the locking ring 23 is disengaged from the catch element 29. However, when the catch element 29 is in the first position, on the one hand the shanks 33 engage with the toothing 27, and on the other hand, the central section 35 abuts the radial end surface of the locking element 23 facing away from the receiving end 17, so that the locking ring 23 is prevented from making an axial movement away from the receiving end 17. In addition, the engagement of the shanks 33 and the toothing 27 prevents twisting of the locking ring 23, and also of the first element 3, due to the non-rotating coupling thereof with the engagement section 7, relative to the second element 13.

The catch element 29 can thus prevent a twisting of the first element 3 out of the locked position into the released position when the catch element is in its first position, in which the shanks 33 engage with the toothing 27.

The catch element 29 thus makes it possible, once the axial length of the Samer rod 1 has been set as described previously, to lock the Samer rod in such a way that it cannot move itself back into the released position of the two elements 3, 13.

Because the coupling ends 5, 15 are connected rotatably about the longitudinal axis 9 to the other part of the first and second element 3, 13, the length of the Samer rod 1 can be adjusted in the manner already described, without needing to release the possibly already permanently mounted coupling ends 5, 15. The length of the Samer rod 1 can thus also be adapted in the installed state. It is in principle sufficient that only one of the two coupling ends 5, 15 is rotatably mounted.

The previously described Samer rod 1 can thus be easily adjusted in terms of its length and it can also be reliably locked in this position once the setting has been realized.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A Samer rod extending along a longitudinal axis having a length adjustable along the longitudinal axis, comprising:
a first element, extending along the longitudinal axis between a first coupling end and an end of an engagement section,
a second element, extending along the longitudinal axis between a second coupling end and a receiving end,
a receiving hole extending away from the receiving end to the second coupling end, which receiving hole extends along the longitudinal axis inside the first element,
the engagement section being provided with an outer row of teeth extending parallel to the longitudinal axis and having evenly spaced teeth extending perpendicular to the longitudinal axis in the circumferential direction of the engagement section,
the receiving hole being provided with an inner row of teeth extending parallel to the longitudinal axis and having evenly spaced teeth extending perpendicular to the longitudinal axis in the circumferential direction of the wall of the receiving hole, the spacing of which, in the direction of the longitudinal axis, corresponds to the spacing of the teeth of the outer row of teeth in the direction of the longitudinal axis,
the engagement section being received in the receiving hole in such a way that the first element is pivotable about the longitudinal axis between a released position and a locked position relative to the second element,
the inner and the outer rows of teeth being disengaged in the released position, so that the engagement section is movable parallel to the longitudinal axis in the receiving hole, and wherein the rows of teeth engage with one another in the locked position, and a movement of the engagement section relative to the receiving hole along the longitudinal axis is prevented,
a locking ring movable along the longitudinal axis and being held in a non-twisting manner on the engagement section, and
a catch device being mounted on the receiving end adjustable between a first position and a second position, wherein the catch device is configured such that, in the first position, the locking ring is coupled to the receiving end in a non-rotating manner and unmovable along the longitudinal axis, and wherein, in the second position, a rotation of the locking ring relative to the receiving end is permitted.

2. The Samer rod according to claim 1,
wherein the locking ring has first engagement elements on its outer circumferential surface and
wherein the catch device has a catch element pivotably held on the second element about a pivot axis extending perpendicular to the longitudinal axis, the catch element being pivotable between the first position and the second position,
wherein the catch element engages with the engagement elements in the first position and is pivoted away from the locking ring in the second position, so that the lock element is disengaged from the engagement elements.

3. The Samer rod according to claim 2, wherein the engagement elements are formed as a toothing on the outer circumference of the locking ring, and wherein the teeth of the toothing extend parallel to the longitudinal axis.

4. The Samer rod according to claim 3,
wherein the catch element has a U-shaped form, with two shanks connected to one another by means of a central section,
wherein the free ends of the shanks are pivotably connected to the receiving end, and
wherein the shanks engage with the toothing and the central section extends along the side of the locking ring facing away from the receiving end in the first position.

5. The Samer rod according to claim 1,
wherein the inner row of teeth has several inner tooth row sections extending linearly parallel to the longitudinal axis and being spaced apart from one another in the circumferential direction of the wall of the receiving hole,
wherein the outer row of teeth has several outer tooth row sections extending linearly parallel to the longitudinal axis and being spaced apart from one another in the circumferential direction of the engagement section, and
wherein at least one of
the width of the inner tooth row sections in the circumferential direction of the wall of the receiving hole corresponds to the spacing of the outer tooth row sections in the circumferential direction of the engagement section, or
the width of the outer tooth row sections in the circumferential direction of the engagement section corresponds to the spacing of the inner tooth row sections in the circumferential direction of the wall of the receiving hole.

6. The Samer rod according to claim 1, wherein at least one of
the first coupling end and the engagement section are rotatably connected to one another about the longitudinal axis, or
the second coupling end and a section of the second element, in which the receiving hole extends, are rotatably connected to one another about the longitudinal axis.
